(19) United States
(12) Patent Application Publication
(10) Pub. No.: US 2026/0127002 A1
(43) Pub. Date: May 7, 2026

(54) BRANCH PREDICTOR

(71) Applicant: Ampere Computing LLC, Santa Clara, CA (US)

(72) Inventors: Michael CHIN, Portland, OR (US); Aaron LINDSAY, Raleigh, NC (US)

(21) Appl. No.: 18/940,591

(22) Filed: Nov. 7, 2024

(51) Int. Cl. G06F 9/38

(52) U.S. Cl. CPC G06F 9/3848; G06F 9/3844; G06F 9/3861

(57) ABSTRACT

Disclosed is a branch predictor unit (BPU), comprising a first branch predictor configured to generate a first prediction of a branch based at least in part on a first prediction entry point of two predictions prior to the first prediction, and a second branch predictor configured to generate a second prediction of the branch based at least in part on a second prediction entry point of one prediction prior to the second prediction, wherein either the first prediction or the second prediction is generated based on a determination of whether the branch follows a flush.

### BACKGROUND OF THE DISCLOSURE

### 1. Field of the Disclosure

Aspects of the disclosure relate generally to branch prediction. More specifically, but not exclusively, to branch prediction for enhanced efficiency.

### 2. Description of the Related Art

Branch predictors have been implemented in processors in an attempt to save computing resources and reduce power consumption. Without branch prediction, a processor core would need to wait until a change of flow instruction for which the next instruction in sequence is not definite (such as a conditional jump instruction or unconditional but indirect branch instruction) has passed the execution stage before the next instruction can enter the fetch stage in the pipeline. A branch predictor may be implemented in the processor core to avoid this waste of time by trying to guess the direction of the change of flow instruction (i.e., whether a jump is most likely to be taken or not taken). The next instruction for the branch direction that is guessed to be the most likely may then be fetched and speculatively executed. If it is later detected that the guess was wrong, then the speculatively executed or partially executed instructions are discarded and the pipeline starts over with the correct branch, thereby incurring a delay. Despite the possibility of misprediction, however, branch predictors have been implemented in modern pipelined processor architectures to achieve higher performance.

Various types of branch predictors have been implemented in pipelined processor architectures. Some branch predictors may be suited for making relatively accurate branch predictions but may have difficulties meeting the timing requirements of modern processor architectures. Some branch predictors may have relatively small and/or fast structures but with reduced prediction accuracy.

Therefore, there is a need for a branch predictor architecture with improved branch prediction performance, improved efficiency, and reduced power consumption.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a branch predictor unit (BPU) includes a first branch predictor configured to generate a first prediction of a branch based at least in part on a first prediction entry point of two predictions prior to the first prediction; and a second branch predictor configured to generate a second prediction of the branch based at least in part on a second prediction entry point of one prediction prior to the second prediction, wherein either the first prediction or the second prediction is generated based on a determination of whether the branch follows a flush.

In some aspects, a method performed at a branch predictor unit (BPU) includes determining whether a branch that is being predicted follows a flush; generating a first prediction of the branch based at least in part on a first prediction entry point of two predictions prior to the first prediction based on a determination that the branch that is being predicted does not follow the flush; and generating a second prediction of the branch based at least in part on a second prediction entry point of one prediction prior to the second prediction based on a determination that the branch that is being predicted follows the flush.

In some aspects, a branch predictor unit (BPU) includes means for determining whether a branch that is being predicted follows a flush; means for generating a first prediction of the branch based at least in part on a first prediction entry point of two predictions prior to the first prediction based on a determination that the branch that is being predicted does not follow the flush; and means for generating a second prediction of the branch based at least in part on a second prediction entry point of one prediction prior to the second prediction based on a determination that the branch that is being predicted follows the flush.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1 illustrates an example of a processing unit, according to aspects of the disclosure.

FIG. 2 illustrates an example of a processor core which includes a branch predictor unit, according to aspects of the disclosure.

FIG. 3 illustrates an example of a block diagram of branch prediction within a processor core, according to aspects of the disclosure.

FIG. 4 illustrates an example of a pipeline diagram of a branch predictor having an NP and an NNP, according to aspects of the disclosure.

FIG. 5 illustrates a flow chart of a method performed at a BPU, according to aspects of the disclosure.

### DETAILED DESCRIPTION

Other objects and advantages associated with the aspects disclosed herein will be apparent to those skilled in the art based on the accompanying drawings and detailed description. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

Various aspects of the subject technology relate to processor structures and techniques for improved branch prediction in processor structures.

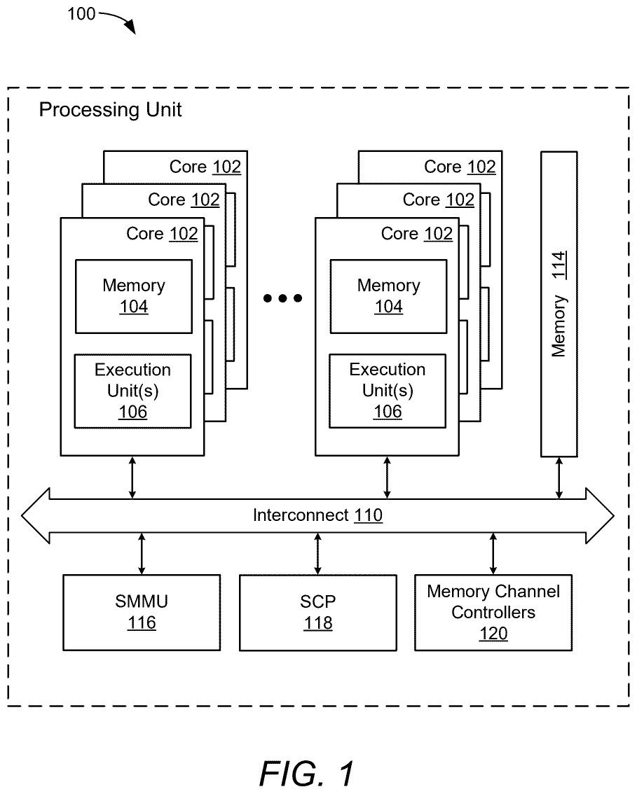

FIG. 1 illustrates an example of a processing unit 100, according to aspects of the disclosure. In some examples, the hardware structures and techniques for branch prediction described herein may be implemented using processing unit 100. Processing unit 100 may be configured as a central processing unit (CPU) but may also be used with or configured as other processing units, such as but not limited to a graphics processing unit (GPU) or tensor processing unit (TPU). Processing unit 100 may include a set of processing cores 102 (or simply “cores” 102). Each core 102 may include memory 104 and one or more execution units 106. Each core 102 may be coupled to interconnect 110, which may be a system on chip (SoC) coherent interconnect. In some examples, memory 104 may be configured as cache on the core 102 (e.g., 16 kB or 64 kB L1 Instruction-cache, 64 kB L1 Data-cache, and 1 MB or 2 MB level 2 (L2) Cache, in some aspects).

The one or more execution units 106 may perform various operations and calculations associated with instructions and micro-operations of the core 102. The one or more execution units 106 may be configured as various units in the core 102 in accordance with various implementations. For example, the one or more execution units 106 may include arithmetic logic units (ALUs) that perform arithmetic and logic operations for the core 102. The one or more execution units 106 may include floating point units (FPUs) that perform floating point calculations. The one or more execution units 106 may include integer execution units (IXUs) for performing integer operations. The one or more execution units 106 may also include single instruction, multiple data (SIMD) execution units for performing various instructions. In some examples, an execution unit 106 may perform a combination of these and other operations. Each of the one or more execution units 106 may include a bus or interconnect, for example, to connect hardware elements of the execution units 106 to memory 104 to perform read and write functions while executing micro-operations. Additionally, or alternatively, one or more execution units 106 including ALUs, FPUs, IXUs, and/or SIMD execution units may be configured for all or a subset of the cores 102.

Processing unit 100 may also include memory 114, which may be coupled to interconnect 110. In some examples, memory 114 may include system-level cache (e.g., 32 MB or 64 MB, in some aspects) that may be used for various purposes by the processing unit 100. Processing unit 100 may also include a system memory management unit (SMMU) 116, The SMMU 116 may provide translation services, for example, to non-processor master units. That is, for example, the SMMU 116 may translate addresses for direct memory address (DMA) requests from system input/output (I/O) devices before the requests are passed to interconnect 110. Processing unit 100 may also include a system control processor (SCP) 118. The SCP 118 may be configured to handle various system management functions. In some examples, the SCP 118 may include separate microcontrollers (or processors). In some examples, the SCP 118 may be combined into one or two microcontrollers, or sub-divided into more than two microcontrollers in accordance with various implementations to handle various system management functions.

Interconnect 110 may be configured as a mesh interconnect that forms a high-speed interface that couples each core 102 to the other cores 102 and other components in processing unit 100. Processing unit 100 may also include memory channel controllers 120 that may be operatively coupled to various memory devices (e.g., external to the processing unit 100). For example, the memory channel controllers 120 may be configured for accessing memory, such as a double data rate (DDR) synchronous dynamic random-access memory (SDRAM) or other memory sources.

It is to be appreciated that the processing unit 100 of FIG. 1 may be configured according to a monolithic die design or a disaggregated chiplet design. That is, for example, in the monolithic die design, the cores 102, interconnect 110, memory 114, SMMU 116, and SCP 118 may be configured on a single die. In some cases, for example, in the disaggregated chiplet design, each chiplet of multiple disaggregated chiplets may include a subset of the cores 102 (e.g., in a tiled fashion) with a memory controller to control a portion of memory 114, and a peripheral component interconnect (PCI) or PCI express (PCIe) controller to control the interface with interconnect 110, SMMU 116, and/or SCP 118. Additionally, or alternatively, other computer architecture designs may be used in various implementations given the benefit of the disclosure.

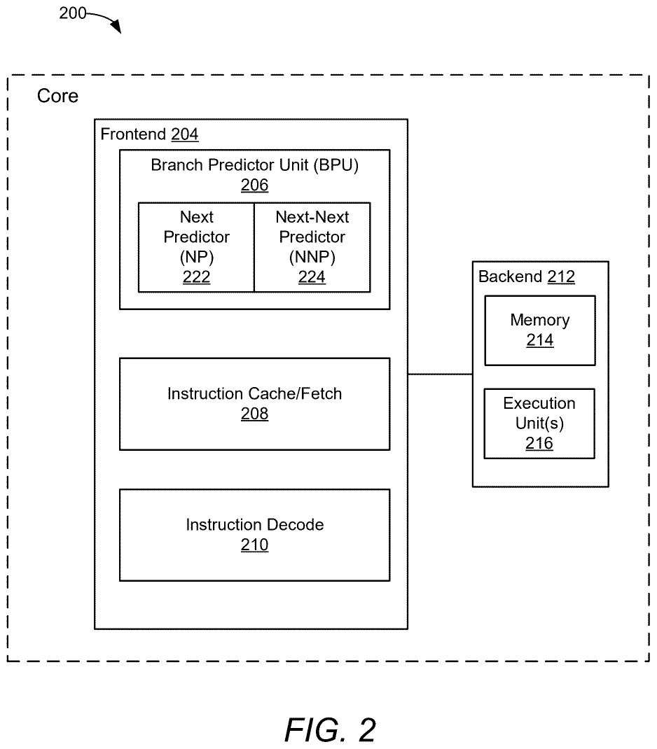

FIG. 2 illustrates an example of a processor core 200 which includes a branch predictor unit (BPU), according to aspects of the disclosure. In some aspects, the core 200 includes a frontend 204, which includes a branch prediction unit (BPU) 206, an instruction cache/fetch 208, an instruction decode 210, and a backend 212, which includes a memory 214 and one or more execution units 216 for executing code, including, for example, code for performing arithmetic, logic and/or other operations.

In some aspects, the frontend 206 may perform fetching of instructions, albeit sometimes by way of other caches and/or external memory. In some situations, upon a flush (i.e. a branch misprediction or other event necessitating stopping and re-starting the frontend), the backend 212 may sometimes send an instruction address to the frontend 204 to instruct it where to restart an instruction fetch, although the backend 212 typically may not send actual instructions to the front end 204. In some aspects, the BPU 206 in the frontend 204 is configured to predict which way a branch (e.g., an if-then-else conditional structure) will go before it is known definitively. In some aspects, the purpose of the BPU is to improve the flow in the instruction pipeline, thus improving the performance of processing in pipelined processor architectures.

In some aspects, the BPU 206 includes at least two branch predictors, according to aspects of the disclosure. In some aspects, the BPU 206, which is part of the frontend 204 of the core 200, includes a next predictor (NP) 222 and a next-next predictor (NNP) 224.

In some aspects, the NNP 224 may be configured to generate a prediction of a branch (including, for example, the branch type, branch location, branch direction, and/or branch target) based at least in part on a first prediction entry point of two predictions prior to the current prediction, and the NP 222 may be configured to generate another prediction of the branch (including, for example, the branch type, branch location, branch direction, and/or branch target) based at least in part on a second prediction entry point of one prediction prior to the current prediction. In some aspects, the prediction entry point may be a cacheline address in which the prediction begins. In some aspects, it may be assumed that each prediction does not span more than a single cacheline and therefore only has one address. In some aspects, the prediction entry point of a prediction may refer to the address of the first instruction to be fetched as part of the prediction, the entry-point address of the cacheline to be predicted, an indicator of the starting point of a prediction, or the like.

In some aspects, two-way branching by a BPU may be implemented with a conditional jump instruction. In some aspects, a conditional jump may either be “taken” and jump to a different place in program memory, or may be “not taken” and continue execution immediately after the conditional jump. In general, it is not known for certain whether a conditional jump will be “taken” or “not taken” until the condition has been calculated and the conditional jump has passed the execution stage in the instruction pipeline (e.g., by the execution units 216 in FIG. 2).

In some aspects, the BPU 206 may provide either the next prediction by the NP 222 or the next-next prediction by the NNP 224), based on a determination of whether the branch that is being predicted follows a flush.

In some aspects, the first prediction entry point may be indexed into an array storing a plurality of potential predictions. In some aspects, the array may be tagged with the second prediction entry point. In some aspects, indexing of the first prediction entry point into the array may be separate from tagging the array with the second prediction entry point.

In some aspects, the NNP 224 may be configured to generate a branch prediction if the branch that is being predicted does not follow a flush. In some aspects, the NP 222 may be configured to generate a branch prediction if the branch that is being predicted follows a flush.

In some aspects, the NNP 224 may include a larger prediction array than the NP 222. In some cases, branch prediction by the NP 222 may be generated in a shorter time than branch prediction generated by the NNP 224. In some cases, branch predictions by the NP 222 and the NNP 224 may be time-shifted relative to one another, as either prediction may be processed earlier or later than the other.

In some aspects, the BPU 206, which includes the NP 222 and the NNP 224, may be part of the frontend 204 of the processor core 200, along with the instruction cache/fetch 208, and the instruction decode 210. In some aspects, the backend 212, including the memory 214 and one or more execution units 216, for example, may be implemented in the processor core 200 to execute the instructions pipelined from the frontend 204. One or more components may be implemented in addition or as an alternative to the components illustrated in FIG. 6 within various aspects of the disclosure.

In some aspects, the NP 222 and the NNP 224 of FIG. 2 may be implemented together as the first or the “earliest” branch predictor in the pipeline. In some aspects, in the NNP 224, a prediction entry point for the cacheline that is being predicted may be indexed by using the previous-previous entry point, that is, the prediction entry point of two predictions prior to the cacheline that is being predicted. In some aspects, the NNP 224 may generate a cacheline prediction such that the Instruction Cache/Fetch 208 may begin looking up an instruction translation lookaside buffer (ITLB) and instruction cache (I-Cache). In some aspects, the NNP 224 may be implemented to generate the first cacheline prediction if there is no flush in the pipeline.

In some aspects, the cacheline that is being predicted may be indexed into an array holding a plurality of potential predictions. In some aspects, the array may be tagged with the prediction entry point of the previous prediction, that is, one prediction prior to the cacheline that is being predicted. In some aspects, the NP 222 may be configured to generate a prediction for the cacheline that is being predicted following a flush by using the previous entry point (i.e., the immediately previous entry point).

In some aspects, the NNP 224 may be indexed separately from how it is tagged because, otherwise during a “normal” prediction, that is, a prediction not following a flush, the NNP 224 may need to be able to consume the prediction entry point just produced by either itself or other predictors (e.g., larger, more accurate predictors such as a branch target buffer (BTB), tagged geometry length predictor (TAGE), indirect target TAGE (ITTAGE), return stack buffer (RSB), or any combination thereof), as it may be difficult to perform all the array accesses in one cycle. In some aspects, with separate indexing of the NNP 224, the NNP 224 may perform a cacheline prediction using the prediction entry point of two predictions prior to the cacheline that is being predicted (i.e., previous-previous prediction), in situations where the cacheline that is being predicted does not follow a flush.

In some aspects, the NP 222, which may have a smaller structure than the NNP 224, may be indexed with only the previous entry point but not the previous-previous entry point, in situations where a cacheline that is being predicted follows a flush.

In some aspects, by splitting the structure of a branch predictor into two, namely, an NNP and an NP, based on what data is easily available in each context (i.e., NNP for a “normal” prediction that is not following a flush, and NP for a prediction that is following a flush), the prediction performance and throughput of the branch predictor may be preserved or even improved regardless of whether any given prediction is following a flush or not, thereby satisfying the stringent timing requirements of modern aggressively pipelined microarchitectures. In some aspects, timing and branch prediction performance may be improved, thereby enabling efficiency in the processor while reducing power usage.

In some aspects, because branch prediction may be an iterative process, it may sometimes or frequently be the case that instruction fetch and decode (and in some cases, execution) may occur concurrently with prediction and not strictly after it. For example, in some instances, the BPU 206, which includes a next predictor (NP) 222 and a next-next predictor (NNP) 224, may make an early prediction, thus allowing instruction fetch to begin. In some instances, instructions may be later cleared (i.e., canceled) if a later, more accurate branch prediction differs from an earlier prediction by the NP 222 and/or NNP 224.

In some aspects, because always indexing with the immediately-previous prediction entry point for a “normal” prediction (i.e. a prediction that is not following a flush) may be prohibitively difficult in some situations due to the address not having been calculated in time in some processor pipelien designs, a smaller predictor structure (e.g., NP 222) similar to NNP 224 but indexed with only the “previous” entry point which, unlike the entry point from two “previous” predictions, is available following a flush. In some aspects, a correct-path entry point address may be used to index the NP 222 following a flush because this index is likely more closely correlated with the predictions, thus improving the accuracy of those predictions.

In some aspects, a technical advantage of the disclosed aspects is that, by splitting a BPU 206 into two parts, namely, an NNP 224 and an NP 222, based on what data is easily available in each usage context (e.g., NNP 224 for “normal” prediction and NP 222 only for predictions following flushes), the prediction performance and throughput of branch predictions following flushes may be improved while preserving aggressive pipelining of the NNP 224 during normal operations.

In some aspects, splitting the NP 222 from the NNP 224 in the BPU 206 may result in additional technical advantages. In some aspects, because the NP 222 is a smaller separate structure from the NNP 224, it may not be tied to the same timing paths as the NNP 224 and can be accessed faster than the NNP 224. Due to the advantage of faster access by the NP 222, addresses may be provided more quickly to the instruction cache than otherwise relying only on the NNP 224, thus allowing flexibility to improve power management and performance in the rest of the processor core 200.

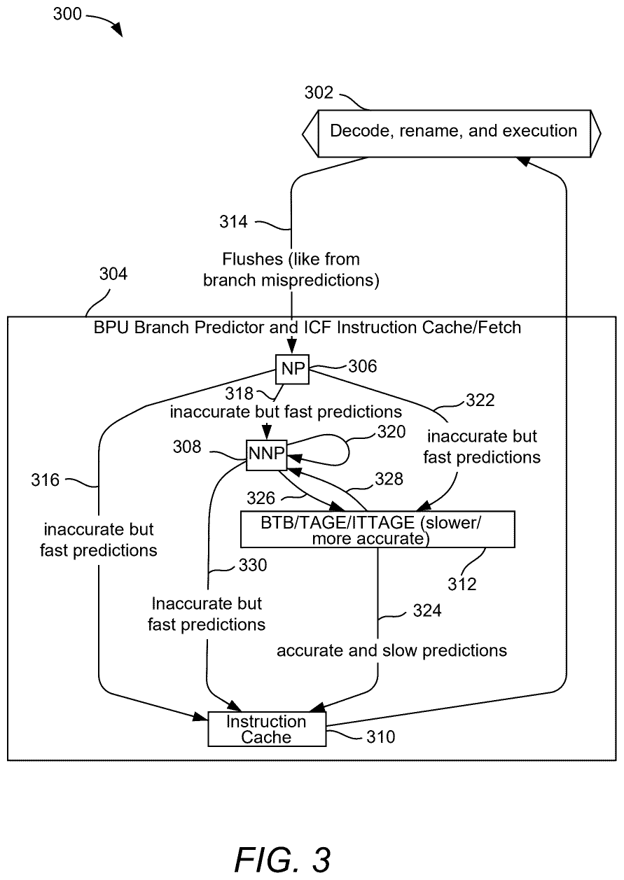

FIG. 3 illustrates an example of a block diagram of branch prediction within a processor core, according to aspects of the disclosure. In the example shown in FIG. 3, a processor core 300 has decode, rename, and execution functionalities 302. The processor core 300 also has a frontend 304 which includes an NP 306 and an NNP 308 as well as other components or functionalities, such as an instruction cache/fetch 310 and/or branch target buffer (BTB)/tagged geometric length predictor (TAGE)/indirect target TAGE (ITTAGE) 312.

In some aspects, the backend 302 may produce a flush, which may be a result of a branch misprediction, for example, as indicated by arrow 314 in FIG. 3. A branch that is to be predicted following a flush may have its branch prediction performed by the NP 306. In some situations, the NP 306 may generate a relatively inaccurate but relatively fast prediction which may be sent directly to the instruction cache 310, as indicated by arrow 316 in FIG. 3.

In some aspects, the NP 306 may send its relatively inaccurate but fast prediction to the NNP 308, as indicated by arrow 318. If the branch that is to be predicted does not follow a flush, then branch prediction may be directly performed by the NNP 308. In some aspects, the NNP 308 may perform branch predictions iteratively to improve its accuracy, as indicated by arrow 320.

In some aspects, the BTB/TAGE/ITTAGE 312 may be provided in the frontend 304 to improve the accuracy of branch predictions. In some aspects, the BTB/TAGE/ITTAGE 312 may generate slower but more accurate predictions. In some aspects, the NP 306 may send its relatively less accurate but faster predictions to the BTB/TAGE/ITTAGE 312 for relatively slower but more accurate predictions, as indicated by arrow 322. The BTB/TAGE/ITTAGE 312 may generate slower but more accurate predictions, which are sent to the instruction cache 310, as indicated by arrow 324.

In some aspects, the NNP 308 may send its predictions to the BTB/TAGE/ITTAGE 312 for slower but more accurate predictions, as indicated by arrow 326. In some aspects, more accurate predictions may be made by the NNP 308 and the BTB/TAGE/ITTAGE 312 in an iterative loop, with a feedback path indicated by arrow 328.

In some aspects, when both the NNP 308 and the BTB/TAGE/ITTAGE 312 are used for more accurate branch prediction, the BTB/TAGE/ITTAGE 312 may confirm a branch prediction by the NNP 308 if the BTB/TAGE/ITTAGE 312 agrees with the prediction made by the NNP 308, or correct the branch prediction made by the NNP 308 if it does not agree. In some aspects, the feedback loop between the BTB/TAGE/ITTAGE 312 to the NNP 308 may be closed only when the BTB/TAGE/ITTAGE 312 disagrees with the NNP 308. During normal operation, the BTB/TAGE/ITTAGE 312 and the NNP 308 are fully pipelined and no feedback is required as long as they continue agreeing with each other.

In some aspects, if the BTB/TAGE/ITTAGE 312 confirms the prediction made by the NNP 308, the prediction may be sent to the instruction cache, as indicated by arrow 324. In some aspects, if the BTB/TAGE/ITTAGE 312 corrects the prediction by the NNP 308, it may redirect the NNP 308 to begin prediction along a corrected execution path. In some aspects, addresses may be sent to the instruction cache by the NP 306 or the NNP 308. In some aspects, the BTB/TAGE/ITTAGE 312 may later correct those predictions and cancel in-progress fetches in the instruction cache, but the instruction cache may not need to wait upon the prediction by BTB/TAGE/ITTAGE 312 to begin fetching instructions.

In some aspects, the NNP 308 may send its relatively less accurate but fast predictions directly to the instruction cache 310 without confirmation by the BTB/TAGE/ITTAGE 312, as indicated by arrow 330. In some situations, the instruction cache 310 may need to receive relatively inaccurate but relatively fast predictions from either the NP 306 (as indicated by arrow 316) or the NNP 308 (as indicated by arrow 330) without incurring extra time needed for the BTB/TAGE/ITTAGE 312 to make more accurate but slower predictions.

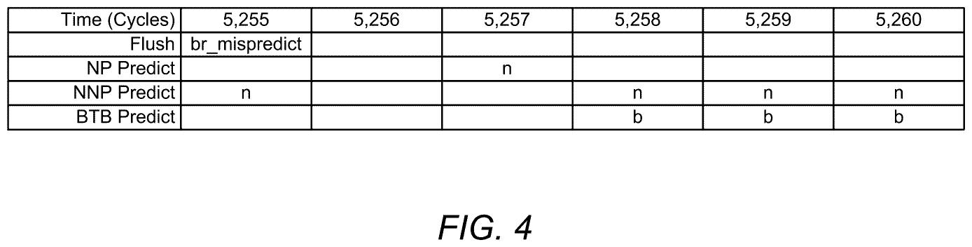

FIG. 4 illustrates an example of a pipeline diagram of a branch predictor having an NP and an NNP, according to aspects of the disclosure. In the example illustrated in FIG. 4, a branch misprediction is indicated as the entry “br_mispredict” in the first row at Time Cycle 5,255. The progress of a first prediction following a branch-misprediction flush (resulting from “br_mispredict”) is next indicated by the entry “n” in the “NP Predict” row at Time Cycle 5,257 (i.e., using the NP for branch prediction). In the “BTB Predict” row at Time Cycle 5,258, the entry “b” indicates further progress of more accurate albeit slower branch prediction by the BTB.

As illustrated in FIG. 4, the entry “n” at Time Cycle 5,258 and the “NNP Predict” row indicates a branch prediction using the NNP (assuming that there was no flush resulting from a branch misprediction). In the “BTB Predict” row at Time Cycle 5,259, the entry “b” indicates that the prediction made by the NNP is further refined by the BTB for more accurate albeit slower prediction.

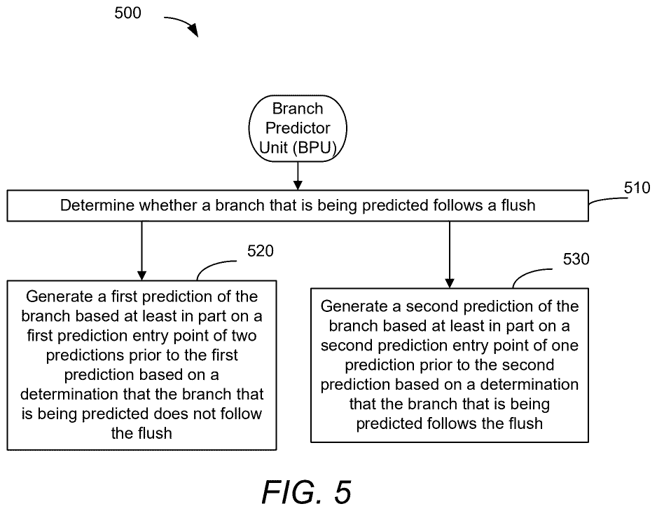

FIG. 5 is a flowchart of an example method 500 performed at a BPU, such as the BPU 206, according to aspects of the disclosure. In some implementations, one or more process blocks of FIG. 5 may be performed by a BPU (e.g., BPU 206). In some implementations, one or more process blocks of FIG. 5 may be performed by another device or a group of devices separate from or including the BPU. Additionally, or alternatively, one or more process blocks of FIG. 5 may be performed by one or more components of one or more processors, any or all of which may be means for performing the operations of method 500.

As shown in FIG. 5, method 500 may include, at operation 510, determining whether a branch that is being predicted follows a flush. Means for performing operation 510 may include any of the apparatuses described herein. For example, the BPU 206 may determine whether a branch that is being predicted follows a flush.

As further shown in FIG. 5, method 500 may include, at operation 520, generating a first prediction of the branch based at least in part on a first prediction entry point of two predictions prior to the first prediction based on a determination that the branch that is being predicted does not follow the flush. Means for performing operation 520 may include any of the apparatuses described herein. For example, the BPU 206 may generate a first prediction of the branch based at least in part on a first prediction entry point of two predictions prior to the first prediction based on a determination that the branch that is being predicted does not follow the flush, using the NNP 224.

As further shown in FIG. 5, method 500 may include, at operation 530, generating a second prediction of the branch based at least in part on a second prediction entry point of one prediction prior to the second prediction based on a determination that the branch that is being predicted follows the flush. Means for performing operation 530 may include any of the apparatuses described herein. For example, the BPU 206 may generate a second prediction of the branch based at least in part on a second prediction entry point of one prediction prior to the second prediction based on a determination that the branch that is being predicted follows the flush, using the NP 222.

Method 500 may include additional implementations, such as any single implementation or any combination of implementations described below and/or in connection with one or more other processes described elsewhere herein.

In some aspects, method 500 includes indexing the first prediction entry point into an array storing a plurality of potential predictions.

In some aspects, method 500 includes tagging the array with a plurality of tag bits.

In some aspects, indexing of the first prediction entry point into the array is separate from tagging the array with the second prediction entry point.

In some aspects, the first prediction is generated by a next-next predictor (e.g., NNP 224), and the second prediction is generated by a next predictor (e. g,, NP 222).

Although FIG. 5 shows example blocks of method 500, in some implementations, method 500 may include additional blocks, fewer blocks, different blocks, or differently arranged blocks than those depicted in FIG. 5. Additionally, or alternatively, two or more of the blocks of method 500 may be performed in parallel, or performed in a sequence different from the sequence listed in FIG. 5. In one or more example aspects, the functions described may be implemented in hardware, software, firmware, or any combination thereof.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended. Furthermore, it is also intended that aspects of a clause can be included in any other independent clause, even if the clause is not directly dependent on the independent clause.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Aspects of the present disclosure are illustrated in the description and related drawings directed to specific embodiments. Alternate aspects or embodiments may be devised without departing from the scope of the teachings herein. Additionally, well-known elements of the illustrative embodiments herein may not be described in detail or may be omitted so as not to obscure the relevant details of the teachings in the present disclosure.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described herein can be configured to perform at least a portion of a method described herein.

In certain described example implementations, instances are identified where various component structures and portions of operations can be taken from known, conventional techniques, and then arranged in accordance with one or more exemplary embodiments. In such instances, internal details of the known, conventional component structures and/or portions of operations may be omitted to help avoid potential obfuscation of the concepts illustrated in the illustrative embodiments disclosed herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Various components as described herein may be implemented as application specific integrated circuits (ASICs), programmable gate arrays (e.g., FPGAs), firmware, hardware, software, or a combination thereof. Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to”, “instructions that when executed perform”, “computer instructions to” and/or other structural components configured to perform the described action.

Those of skill in the art further appreciate that the various illustrative logical blocks, components, agents, IPs, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, processors, controllers, components, agents, IPs, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Nothing stated or illustrated depicted in this application is intended to dedicate any component, action, feature, benefit, advantage, or equivalent to the public, regardless of whether the component, action, feature, benefit, advantage, or the equivalent is recited in the claims.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or one or more claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions and/or functionalities of the methods disclosed.

Furthermore, in some examples, an individual action can be subdivided into one or more sub-actions or contain one or more sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

1. A branch predictor unit (BPU), comprising:
a first branch predictor configured to generate a first prediction of a branch based at least in part on a first prediction entry point of two predictions prior to the first prediction, wherein the first prediction entry point is stored as a first set of tag bits in an array that stores a plurality of potential predictions; and
a second branch predictor configured to generate a second prediction of the branch based at least in part on a second prediction entry point of one prediction prior to the second prediction, wherein either the first prediction or the second prediction is generated based on a determination of whether the branch follows a flush, wherein the second prediction entry point is stored as a second set of tag bits in the array separate from the first set of tag bits.

2-4. (canceled)

5. The BPU of claim 1, wherein the second branch predictor is configured to generate the second prediction if the branch follows the flush.

6. The BPU of claim 1, wherein the first branch predictor is configured to generate the first prediction if the branch does not follow the flush.

7. The BPU of claim 1, wherein the first branch predictor comprises a larger prediction array than the second branch predictor.

8. The BPU of claim 1, wherein the second prediction is generated in a shorter time than the first prediction.

9. The BPU of claim 1, wherein the first branch predictor comprises a next-next predictor (NNP).

10. The BPU of claim 1, wherein the second branch predictor comprises a next predictor (NP).

11. A method performed at a branch predictor unit (BPU), the method comprising:
determining whether a branch that is being predicted follows a flush;
generating a first prediction of the branch based at least in part on a first prediction entry point of two predictions prior to the first prediction based on a determination that the branch that is being predicted does not follow the flush, wherein the first prediction entry point is stored as a first set of tag bits in an array that stores a plurality of potential predictions; and
generating a second prediction of the branch based at least in part on a second prediction entry point of one prediction prior to the second prediction based on a determination that the branch that is being predicted follows the flush, wherein the second prediction entry point is stored as a second set of tag bits in the array separate from the first set of tag bits.

12-14. (canceled)

15. The method of claim 11, wherein the first prediction is generated by a next-next predictor (NNP), and wherein the second prediction is generated by a next predictor (NP).

16. A branch predictor unit (BPU), comprising:
means for determining whether a branch that is being predicted follows a flush;
means for generating a first prediction of the branch based at least in part on a first prediction entry point of two predictions prior to the first prediction based on a determination that the branch that is being predicted does not follow the flush, wherein the first prediction entry point is stored as a first set of tag bits in an array that stores a plurality of potential predictions; and
means for generating a second prediction of the branch based at least in part on a second prediction entry point of one prediction prior to the second prediction based on a determination that the branch that is being predicted follows the flush, wherein the second prediction entry point is stored as a second set of tag bits in the array separate from the first set of tag bits.

17-19. (canceled)

20. The BPU of claim 16, wherein the first prediction is generated by a next-next predictor (NNP), and wherein the second prediction is generated by a next predictor (NP).
